(19) United States
(12) Patent Application Publication
(10) Pub. No.: US 2018/0361988 A1
(43) Pub. Date: Dec. 20, 2018

(54) BUCKLE DEVICE

(71) Applicant: KABUSHIKI KAISHA TOKAI-RIKA-DENKI-SEISAKUSHO, Aichi-ken (JP)

(72) Inventors: Daiki KATO, Aichi-ken (JP); Tomotaka SUZUKI, Aichi-ken (JP); Tetsushi URUSHIBATA, Aichi-ken (JP); Kentaro YAMADA, Aichi-ken (JP)

(21) Appl. No.: 16/008,185

(22) Filed: Jun. 14, 2018

(30) Foreign Application Priority Data
Jun. 20, 2017 (JP) 2017-120804

(51) Int. Cl. B60R 22/48

(52) U.S. Cl. CPC B60R 22/48; B60R 2022/4816

(57) ABSTRACT

A buckle device includes a buckle into which a tongue of a seatbelt device is inserted and that engages with the tongue, a magnetic sensor that is provided to the buckle and that detects nearby changes in magnetism; and an antenna that is provided to the buckle, that is configured to be able to at least transmit an electrical signal to outside of the buckle or receive an electrical signal from outside of the buckle, that is disposed overlapping at least a portion of the magnetic sensor, and that is configured to be able to suppress electromagnetic waves or magnetism from the outside of the buckle from influencing the magnetic sensor.

### CROSS-REFERENCE TO RELATED APPLICATION

This application is based on and claims priority under 35 USC 119 from Japanese Patent Application No. 2017-120804 filed on Jun. 20, 2017, the disclosure of which is incorporated by reference herein.

### BACKGROUND

### Technical Field

The present disclosure relates to a buckle device that engages with a tongue of a seatbelt device.

### Related Art

Japanese Patent Application Laid-Open (JP-A) No. 2001-224408 discloses an example of a buckle device that is provided with a magnetic sensor inside a buckle cover. In this type of buckle device, in order to suppress magnetism, electromagnetic waves, and the like from the outside of the buckle device from influencing the magnetic sensor, a shield member may be provided to the device, or to a circuit configured including the magnetic sensor. However, providing such a shield member increases the number of components configuring the buckle device.

### SUMMARY

In consideration of the above circumstances, the present disclosure obtains a buckle device capable of suppressing at least one out of magnetism or electromagnetic waves from outside of the buckle device from influencing a magnetic sensor, and also capable of suppressing an increase in the number of components.

A buckle device of a first aspect of the present disclosure includes a buckle, a magnetic sensor, and an antenna. A tongue of a seatbelt device is inserted into the buckle, and the buckle engages with the tongue. The magnetic sensor is provided at the buckle and detects surrounding changes in magnetism. The antenna is provided at the buckle, is configured to at least transmit an electrical signal to outside of the buckle or receive an electrical signal from outside of the buckle, is disposed overlapping at least a portion of the magnetic sensor, and is configured to be able to suppress electromagnetic waves or magnetism from the outside of the buckle from influencing the magnetic sensor.

According to the buckle device of the first aspect of the present disclosure, the buckle is provided with the antenna. The antenna is configured to at least transmit an electrical signal to outside of the buckle or receive an electrical signal from outside of the buckle. Moreover, the antenna is disposed overlapping at least a portion of the magnetic sensor, and accordingly suppresses at least one out of electromagnetic waves or magnetism from the outside of the buckle from influencing the magnetic sensor. There is accordingly no need to provide a shield member separately to the antenna in order to shield the at least one out of electromagnetic waves or magnetism, thereby enabling a reduction in the number of components.

A buckle device of a second aspect of the present disclosure is the buckle device of the first aspect, wherein the antenna includes a coil portion formed in a coil shape, and at least a portion of the magnetic sensor is disposed inside the coil portion.

According to the buckle device of the second aspect of the present disclosure, the antenna includes the coil portion that is formed in a coil shape. At least a portion of the magnetic sensor is disposed inside the coil portion of the antenna. This thereby enables electromagnetic waves or magnetism from the outside of the coil portion to be effectively suppressed from influencing the magnetic sensor.

A buckle device of a third aspect of the present disclosure is the buckle device of the second aspect, wherein the coil portion of the antenna is wound around a portion of the buckle at a side through which the tongue is inserted.

In the buckle device of the third aspect of the present disclosure, the coil portion of the antenna is wound around a portion of the buckle at the side through which the tongue is inserted. This thereby enables the strength of the portion of the buckle on the side through which the tongue is inserted to be increased.

A buckle device of a fourth aspect of the present disclosure is the buckle device of either the second aspect or the third aspect, wherein the buckle includes a buckle body and a cover. The buckle body includes an engagement member that engages with the tongue. The buckle body is provided inside the cover, and the coil portion of the antenna is wound around the cover.

According to the buckle device of the fourth aspect of the present disclosure, the coil portion of the antenna is wound around the cover of the buckle, enabling the strength of the cover to be increased.

A buckle device of a fifth aspect of the present disclosure is the buckle device of either the first aspect or the second aspect, wherein the buckle includes a buckle body and a cover. The buckle body includes an engagement member that engages with the tongue. The buckle body is provided inside the cover. Moreover, the antenna is provided at a side of the buckle body inside the cover.

According to the buckle device of the fifth aspect of the present disclosure, the antenna is disposed at a side of the buckle body inside the cover. This thereby enables a space at the side of the buckle body inside the cover of the buckle to be utilized effectively.

A buckle device of a sixth aspect of the present disclosure is the buckle device of the second aspect, wherein the buckle includes a buckle body and a cover. The buckle body includes an engagement member that engages with the tongue. The buckle body is provided inside the cover. Moreover, the coil portion is provided at least at a side of the buckle body inside the cover.

According to the buckle device of the sixth aspect of the present disclosure, the coil portion is disposed at least at a side of the buckle body inside the cover. This thereby enables a space at least at the side of the buckle body inside the cover of the buckle to be utilized effectively.

A buckle device of a seventh aspect of the present disclosure is the buckle device of the second aspect, wherein at least the coil portion of the antenna is covered by an insulating covering material, and a surface of the covering material is configured including a magnetic material having a relative permeability greater than 1.

According to the buckle device of the seventh aspect of the present disclosure, magnetism from the outside of the coil portion passes through the coil portion at least at a coating layer portion configured by the magnetic material. This thereby enables magnetism from the outside of the coil portion of the antenna to be at least suppressed from passing through the coil portion and reaching the inside of the coil portion. Magnetism from the outside of the coil portion can thus be suppressed from influencing the magnetic sensor disposed inside the coil portion.

As described above, the buckle device according to the present disclosure is capable of suppressing at least one out of magnetism or electromagnetic waves from outside of the buckle device from influencing a magnetic sensor, and is also capable of suppressing an increase in the number of components.

### BRIEF DESCRIPTION OF THE DRAWINGS

Exemplary embodiments of the present invention will be described in detail based on the following figures, wherein:

FIG. 1 is an exploded perspective view of a buckle device according to a first exemplary embodiment;

FIG. 2 is a side view cross-section of a buckle device according to the first exemplary embodiment, as viewed from a device right side;

FIG. 3 is a schematic plan view illustrating a positional relationship between a coil portion of a coil antenna and an MR sensor of an MR switch in a buckle device according to the first exemplary embodiment;

FIG. 4 is a schematic plan view illustrating a positional relationship between a coil portion of a coil antenna and an MR sensor of an MR switch in a buckle device according to a second exemplary embodiment;

FIG. 5 is a schematic plan view illustrating a positional relationship between a coil portion of a coil antenna and an MR sensor of an MR switch in a buckle device according to a third exemplary embodiment; and

FIG. 6 is a schematic plan view illustrating a positional relationship between a coil portion of a coil antenna and an MR sensor of an MR switch in a buckle device according to a fourth exemplary embodiment.

### DETAILED DESCRIPTION

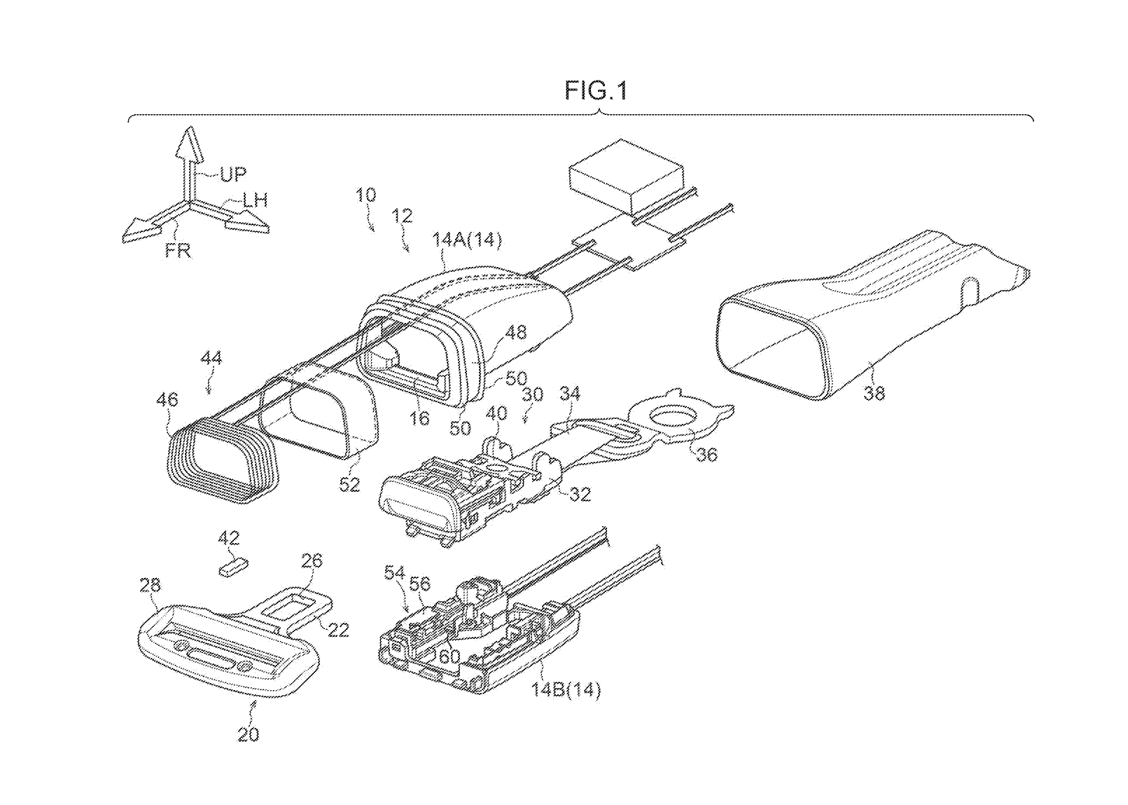

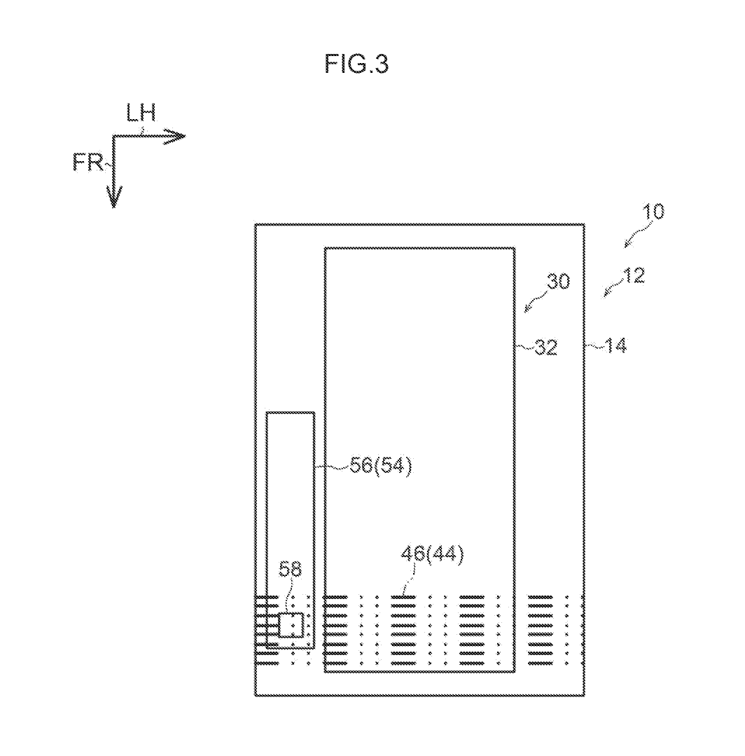

Explanation follows regarding exemplary embodiments of the present disclosure, with reference to FIG. 1 to FIG. 6. In the drawings, arrow FR indicates a device front side of a buckle device 10, arrow LH indicates a device left side of the buckle device 10, and arrow UP indicates a device upper side of the buckle device 10. In the respective exemplary embodiments, locations that are basically the same as those of a foregoing exemplary embodiment are allocated the same reference numerals thereto, and detailed explanation of such locations is omitted.

### First Exemplary Embodiment

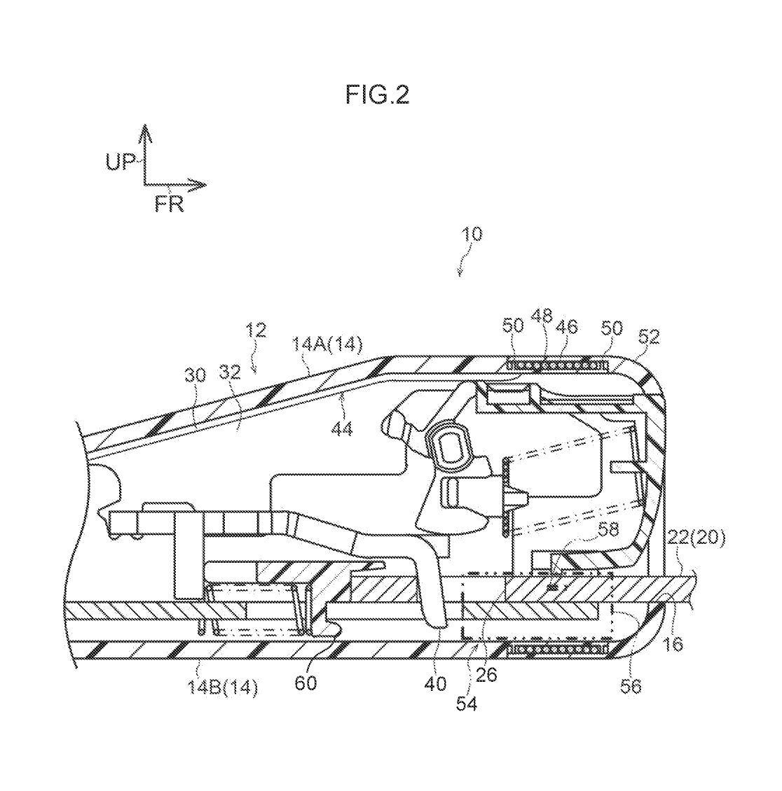

As illustrated in FIG. 1, the buckle device 10 includes a buckle 12. The buckle 12 includes a cover 14. The cover 14 is configured including an upper cover 14A forming a device upper side portion of the cover 14, and a lower cover 14B forming a device lower side portion of the cover 14. The cover 14 is formed from a synthetic resin material. The cover 14 is open at a device front side end portion thereof. A device lower side portion of the opening at the device front side of the cover 14 configures a tongue insertion opening 16. A device rear side portion of a tongue 20 provided to a webbing (not illustrated in the drawings) of a seatbelt device enters the inside of the cover 14 from the device front side of the cover 14 through the tongue insertion opening 16 (see FIG. 2).

As illustrated in FIG. 1, the tongue 20 includes a core 22. The core 22 is formed from a metal such as iron, and a thickness direction of the core 22 runs substantially in the device up-down direction (the arrow UP direction and the opposite direction thereto in FIG. 1, etc.). A device rear side portion of the core 22 enters the inside of the cover 14 through the tongue insertion opening 16. Moreover, the device rear side portion of the core 22 is formed with an engagement hole 26. The engagement hole 26 penetrates the core 22 in the thickness direction of the core 22.

A device front side portion of the tongue 20 is provided with a molded portion 28. The molded portion 28 is formed from a synthetic resin material. The molded portion 28 covers a device front side portion of the core 22.

As illustrated in FIG. 1 and FIG. 2, a buckle body 30 is provided inside the cover 14. Together, the cover 14 and the buckle body 30 configure the buckle 12. The buckle body 30 includes a body 32. The body 32 is formed from a metal, for example iron or stainless steel. A device rear side end portion of the body 32 is fixed to a vehicle body side, such as a seat frame member, at the side of a vehicle seat using a coupling belt 34 and an anchor 36. As illustrated in FIG. 1, the buckle device 10 also includes a boot 38. A device rear side portion of the cover 14, as well as the coupling belt 34 and the anchor 36, are disposed inside the boot 38.

As illustrated in FIG. 1 and FIG. 2, the buckle device 10 includes a latch 40, serving as an engagement member. A device rear side end portion of the latch 40 is supported by the body 32, and the latch 40 is capable of pivoting about the device rear side end portion of the latch 40, about an axis having an axial direction running in the device left-right direction. As illustrated in FIG. 2, the latch 40 pivots in a state in which the tongue 20 has entered the inside of the cover 14. A device front side portion of the latch 40 is disposed passing through the engagement hole 26 in the tongue 20, such that the device front side portion of the latch 40 limits movement of the tongue 20 toward the device front side.

As illustrated in FIG. 1, the tongue 20 is provided with a transponder 42, serving as a response transmitter. In the present exemplary embodiment, a Radio Frequency Identification (RFID) tag is provided as the transponder 42. The transponder 42 includes a transponder coil and a microchip (neither of which are illustrated in the drawings). In FIG. 1, the transponder 42 is illustrated separately to the tongue 20. However, as an example of the placement of the transponder 42 with respect to the tongue 20, the transponder 42 is embedded in the molded portion 28 of the tongue 20.

The buckle 12 is provided with a coil antenna 44, serving as an antenna, at a location corresponding to the transponder 42. The coil antenna 44 includes a conducting wire formed from a diamagnetic conductor, such as copper. The conducting wire is covered by an insulating tube-shaped covering material configured from a synthetic resin material or the like. Moreover, an outer surface of the covering material is formed with a coating layer. The coating layer is configured including a magnetic material having a relative permeability greater than 1.

The coil antenna 44 includes a coil portion 46 configuring a shielding member, serving as a magnetism shielding member and an electromagnetic wave shielding member. The coil portion 46 is formed by coiling the conducting wire configuring the coil antenna 44 into a tube shape, and an axial center direction of the coil portion 46 (transmission/reception axial direction) runs substantially in the device front-rear direction. The cover 14 (upper cover 14A) is provided with a coil placement portion 48 at a location corresponding to the coil portion 46.

The coil placement portion 48 is disposed at a device front side end portion of the cover 14. The thickness of the cover 14 at the coil placement portion 48 is thinner than the thickness of a portion of the cover 14 at the device rear side of the coil placement portion 48. An outer face of the cover at the coil placement portion 48 is offset toward the inside of the cover 14 with respect to the outer face of the cover at a portion of the cover 14 at the device rear side of the coil placement portion 48. Moreover, the coil placement portion 48 is provided with a pair of ribs 50. The ribs 50 are formed projecting from the cover outer face at the coil placement portion 48. One of the ribs 50 is disposed at a device rear side end portion of the coil placement portion 48, and the other rib 50 is disposed at a device front side end portion of the coil placement portion 48. The coil portion 46 of the coil antenna 44 is wound around the cover outer face, between the two ribs 50, at the coil placement portion 48 of the cover 14 (namely, at the device front side end portion of the cover 14).

The coil placement portion 48 is provided with a protector 52. The protector 52 is formed from a synthetic resin material in a ring shape corresponding to the shape of the device front side end portion of the cover 14. When the protector 52 is mounted to the coil placement portion 48, the coil portion 46 of the coil antenna 44 is covered by the protector 52.

The coil antenna 44 enters the inside of the cover 14 and extends along the device upper side portion of the cover 14 toward the device rear side at a portion on one end side and a portion on the other end side of the coil portion 46. The coil antenna 44 is electrically connected to an ECU (not illustrated in the drawings), serving as a controller, through the portion on the one end side and the portion on the other end side of the coil portion 46. The coil antenna 44 is capable of exchanging radio waves (signals) with the transponder 42 provided to the tongue 20. The coil antenna 44 transmits and receives radio waves (signals) including an encrypted ID code pre-stored in the microchip of the transponder 42 or the like. Based on the ID code or the like included in the radio waves (signals) received by the coil antenna 44, the ECU determines which seat the tongue of the transponder 42 belongs to.

As illustrated in FIG. 1, an MR switch 54, this being one configuration of a magnetic proximity switch, is provided as a moving body detector. The MR switch 54 is provided with housing 56. The housing 56 is disposed inside the cover 14, at the device right side of the body 32. The MR switch 54 includes a bridge circuit (not illustrated in the drawings) configured including a Magneto Resistive sensor 58, serving as a magnetic sensor (“magneto resistive sensor 58” is abbreviated to “MR sensor 58” hereafter). The bridge circuit is provided inside the housing 56, and is electrically connected to the ECU (not illustrated in the drawings).

The MR switch 54 includes a slide member 60. The slide member 60 is capable of sliding in the device front-rear direction. Part of the slide member 60 projects out from the housing 56 toward the device left side, and a leading end portion of the slide member 60 on the side projecting from the housing 56 enters the inside of the body 32. The leading end portion on the projecting side of the slide member 60 is capable of directly or indirectly engaging with the tongue 20 inserted into the cover 14. The slide member 60 is moved toward the device rear side by inserting the tongue 20 further into the cover 14 in a state in which the tongue 20 has already engaged with the slide member 60 (by moving the tongue 20 toward the device rear side inside the cover 14).

A permanent magnet (not illustrated in the drawings) is provided to a portion of the slide member 60 that is provided in the housing 56. The permanent magnet moves in the device front-rear direction together with the slide member 60. Magnetic flux of the magnetic field created by the permanent magnet passes through the MR sensor 58 of the MR switch 54, and the magnetic flux of the magnetic field of the permanent magnet passing through the MR sensor 58 changes depending on the slide position of the permanent magnet in the device front-rear direction. The impedance of the MR sensor 58 changes accompanying these changes in the magnetic flux passing through the MR sensor 58. It is thus possible to detect whether or not the tongue 20 has been inserted as far as a predetermined position inside the cover 14 based on the changes in the impedance of the MR sensor 58.

Note that at least a portion of the MR switch 54 is disposed inside the coil portion 46 of the coil antenna 44 described above. The MR sensor 58 of the MR switch 54 is disposed at the inside of the coil portion 46 and substantially at the device front-rear direction center of the coil portion 46.

When an occupant seated in the vehicle seat applied with the buckle device 10 fits the webbing over their body, the webbing is entrained over the body of the occupant at the vehicle front side of the body of the occupant. In this state, the tongue 20 approaches a device front side end of the cover 14. When the distance between the tongue 20 and the device front side end of the cover 14 is below a specific value, the radio waves (signals) transmitted from transponder 42 provided to the tongue 20 are received by the coil antenna 44 provided to the cover 14 of the buckle 12. When an electrical signal based on these radio waves is input to the ECU, for example, the ECU determines whether or not the tongue 20 that has approached the buckle 12 is the tongue 20 corresponding to that buckle 12 (namely, whether or not the tongue is a tongue belonging to a seatbelt device of another vehicle seat).

Next, a device rear side portion of the core 22 of the tongue 20 is inserted inside the cover 14 through the tongue insertion opening 16 in the cover 14. The tongue 20 inserted into the cover 14 engages directly or indirectly with the portion of the slide member 60 of the MR switch 54 that is disposed inside the body 32. In this state, when the tongue 20 is inserted further into the cover 14, the slide member 60 is moved toward the device rear side together with the tongue 20, and the permanent magnet provided to the slide member 60 slides toward the device rear side together with the slide member 60. The permanent magnet of the slide member 60 thus moves relative to the MR sensor 58 of the MR switch 54. The magnetic flux of the magnetic field of the permanent magnet passing through the MR sensor 58 accordingly changes, resulting in a change in the impedance of the MR sensor 58.

In this manner, when the tongue 20 is inserted further into the cover 14 until a state is reached in which the latch 40 provided to the body 32 can pivot and the device front side portion of the latch 40 can be disposed so as to pass through the engagement hole 26 in the tongue 20, the level of the electrical signal output from the MR switch 54 switches, for example causing an indicator light provided on an instrument panel or the like in the vehicle to be extinguished.

Note that in the present exemplary embodiment, the MR sensor 58 of the MR switch 54 is disposed substantially at the device front-rear direction center of the coil portion 46, at the inside of the coil portion 46 of the coil antenna 44. The coating layer is formed around the outer face of the tube-shaped covering portion of the coil antenna 44. The coating layer is configured including a magnetic material having a relative permeability greater than 1. Magnetism from the outside of the coil portion 46 of the coil antenna 44 accordingly passes through a portion of the coating layer of the coil portion 46 configured from a magnetic material. This thereby enables magnetism from the outside of the coil portion 46 of the coil antenna 44 to be suppressed from passing through the coil portion 46 and reaching the inside of the coil portion 46, and enables magnetism from the outside of the coil portion 46 to be suppressed from influencing the MR sensor 58 of the MR switch 54 disposed inside the coil portion 46.

The coil antenna 44 includes the conducting wire formed from an electrically conductive material such as copper, and also includes the coating layer configured including a magnetic material. Accordingly, should electromagnetic waves generated by mobile telephones, handheld game devices, or the like attempt to pass through the coil portion 46 and enter inside the coil portion 46 of the coil antenna 44, these electromagnetic waves generate an eddy current in the coil portion 46, thereby attenuating the electromagnetic waves. Accordingly, electromagnetic waves from the outside of the coil portion 46 can be suppressed from influencing the MR sensor 58 of the MR switch 54 disposed inside the coil portion 46 of the coil antenna 44.

Since the coil portion 46 of the coil antenna 44 is capable of suppressing magnetism from the outside of the coil portion 46 from influencing the MR sensor 58 of the MR switch 54, there is no need to provide a magnetism shielding member or an electromagnetic wave shielding member for the MR sensor 58 separately to the coil portion 46 of the coil antenna 44. This thereby enables an increase in the number of components of the buckle device 10 to be suppressed.

Moreover, the axial center direction (transmission/reception axial direction) of the coil portion 46 of the coil antenna 44 runs substantially in the device front-rear direction, and the axial center direction (transmission/reception axial direction) of the coil portion 46 runs in the direction in which the tongue 20 moves when the tongue 20 is inserted into the cover 14 or when the tongue 20 is removed from the cover 14. This thereby enables the precision of transmission and reception of radio waves (signals) between the transponder 42 provided to the tongue 20 and the coil antenna 44 to be increased.

Moreover, in the present exemplary embodiment, the coil portion 46 of the coil antenna 44 is wound onto the coil placement portion 48 at the device front side end portion of the cover 14. The device front side end portion of the cover 14 can thus be reinforced, enabling the mechanical strength, for example the bending strength, of the device front side end portion of the cover 14 to be raised. For example, load is applied to the device front side end portion of the cover 14 when inserting the tongue 20 inside the cover 14 and when performing a release operation to detach the tongue 20 from the buckle device 10. In the present exemplary embodiment, since the device front side end portion of the cover 14 can be reinforced as described above, strength with respect to such load can be obtained without, for example, specifically increasing the thickness of the device front side end portion of the cover 14.

### Second Exemplary Embodiment

Next, explanation follows regarding a second exemplary embodiment.

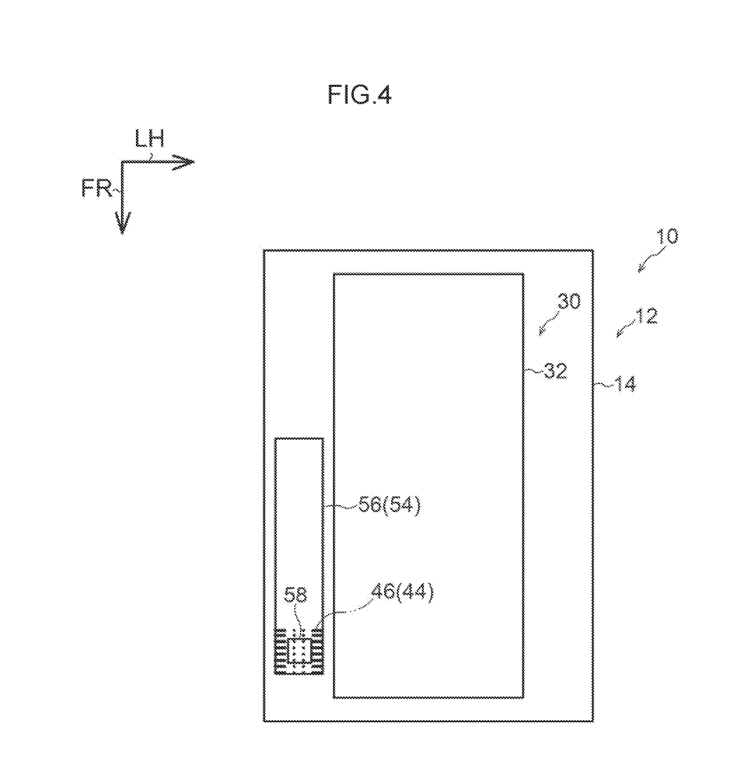

As illustrated in FIG. 4, in the present exemplary embodiment, the coil portion 46 of the coil antenna 44 is provided to the housing 56 of the MR switch 54. The axial center direction (transmission/reception axial direction) of the coil portion 46 runs substantially in the device front-rear direction, and the coil portion 46 is wound around a device front side portion of the housing 56. Moreover, the MR sensor 58 of the MR switch 54 is provided at the inside of the coil portion 46. The MR sensor 58 is disposed substantially at the device front-rear direction center of the coil portion 46.

In the present exemplary embodiment, magnetism and electromagnetic waves from the outside of the coil portion 46 of the coil antenna 44 can thus be suppressed from passing through the coil portion 46 and reaching the inside of the coil portion 46. Magnetism from the outside of the coil portion 46 can accordingly be suppressed from influencing the MR sensor 58 of the MR switch 54 disposed inside the coil portion 46 of the coil antenna 44.

The coil portion 46 of the coil antenna 44 is capable of suppressing magnetism (or electromagnetic waves) from the outside of the coil portion 46 from influencing the MR sensor 58 of the MR switch 54. There is thus no need to provide a magnetism shielding member (or an electromagnetic wave shielding member) for the MR sensor 58 separately to the coil portion 46 of the coil antenna 44. This thereby enables an increase in the number of components of the buckle device 10 to be suppressed.

Moreover, in the present exemplary embodiment, the coil portion 46 of the coil antenna 44 is provided on the device right side of the body 32 of the buckle 12. Moreover, the coil portion 46 is wound around the housing 56 of the MR switch 54. This thereby enables a common placement space to be employed as a placement space for the coil portion 46 and a placement space for the housing 56 of the MR switch 54, and so there is no need to set a placement space for the coil portion 46 separately to a placement space for the housing 56 of the MR switch 54. Moreover, the coil portion 46 of the coil antenna 44 can be assembled inside the cover 14 of the buckle 12 by assembling the housing 56 of the MR switch 54 inside the cover 14 of the buckle 12.

### Third Exemplary Embodiment

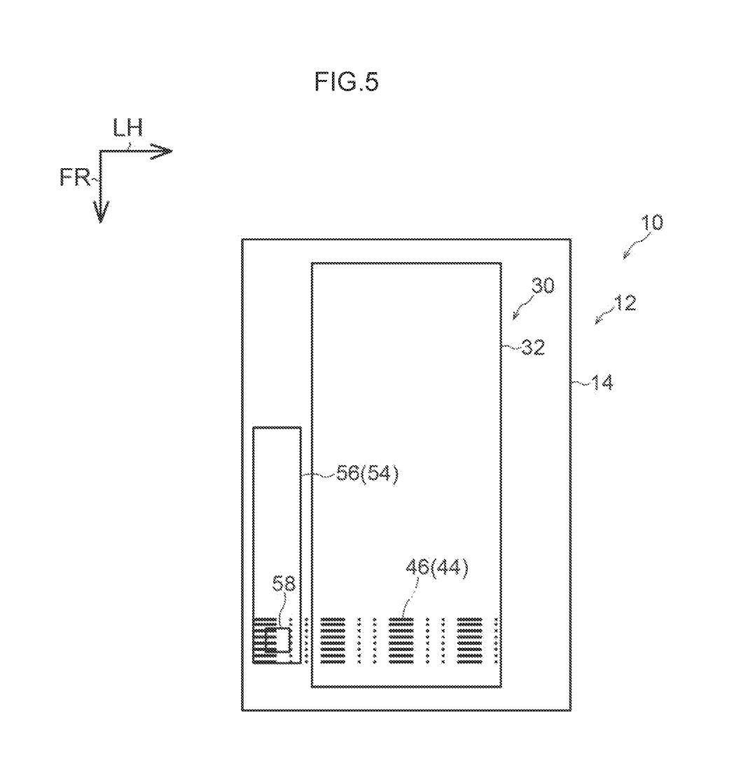

As illustrated in FIG. 5, in the present exemplary embodiment, the coil portion 46 of the coil antenna 44 is wound around both a device front side portion of the body 32 of the buckle 12 and a device front side portion of the housing 56 of the MR switch 54. The axial center direction (transmission/reception axial direction) of the coil portion 46 runs substantially in the device front-rear direction, and the MR sensor 58 of the MR switch 54 is disposed at the inside of the coil portion 46, substantially at the device front-rear direction center of the coil portion 46.

Accordingly, in the present exemplary embodiment, magnetism and electromagnetic waves from the outside of the coil portion 46 of the coil antenna 44 can be suppressed from passing through the coil portion 46 and reaching the inside of the coil portion 46. This thereby enables magnetism from the outside of the coil portion 46 to be suppressed from influencing the MR sensor 58 of the MR switch 54 disposed inside the coil portion 46 of the coil antenna 44.

Moreover, since the coil portion 46 of the coil antenna 44 is capable of suppressing magnetism (or electromagnetic waves) from the outside of the coil portion 46 from influencing the MR sensor 58 of the MR switch 54, there is no need to provide a magnetism shielding member (or an electromagnetic wave shielding member) for the MR sensor 58 separately to the coil portion 46 of the coil antenna 44. This thereby enables an increase in the number of components of the buckle device 10 to be suppressed.

### Fourth Exemplary Embodiment

Next, explanation follows regarding a fourth exemplary embodiment.

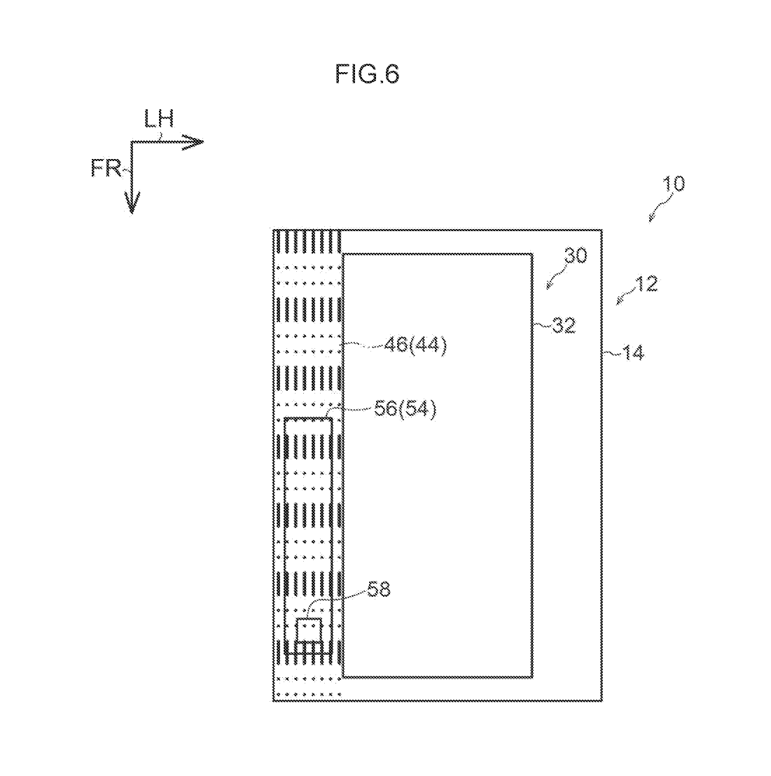

As illustrated in FIG. 6, in the present exemplary embodiment, the coil portion 46 of the coil antenna 44 is provided to the cover 14 of the buckle 12. The axial center direction (transmission/reception axial direction) of the coil portion 46 runs substantially in the device left-right direction, and the coil portion 46 is wound around a device right side portion of the cover 14. Moreover, the MR sensor 58 of the MR switch 54 is provided at the inside of the coil portion 46. The MR sensor 58 is disposed substantially at the device left-right direction center of the coil portion 46.

Accordingly, in the present exemplary embodiment, magnetism and electromagnetic waves from the outside of the coil portion 46 of the coil antenna 44 can be suppressed from passing through the coil portion 46 and reaching the inside of the coil portion 46. This thereby enables magnetism from the outside of the coil portion 46 to be suppressed from influencing the MR sensor 58 of the MR switch 54 disposed inside the coil portion 46 of the coil antenna 44.

Note that in each of the exemplary embodiments described above, the coating layer is formed on an outer face of the tube covering the conducting wire of the coil antenna 44. The coating layer is configured including a magnetic material, such that electromagnetic waves from the outside of the coil portion 46 are suppressed from influencing the MR sensor 58 of the MR switch 54 disposed inside the coil portion 46 of the coil antenna 44.

However, for example, the conducting wire of the coil antenna 44, or the tube, may be formed from a magnetic material having a relative permeability greater than 1. Namely, the specific configuration of the coil antenna 44 is not particularly limited so long as the coil portion 46 of the coil antenna 44 is capable of suppressing magnetism from the outside of the coil portion 46 from influencing the MR sensor 58 inside the coil portion 46.

Moreover, in each of the exemplary embodiments described above, the MR sensor 58 of the MR switch 54 is disposed at either the device front-rear direction central side or the device left-right direction central side at the inside of the coil portion 46 of the coil antenna 44. However, the MR sensor 58 of the MR switch 54 may be disposed at the device front side, device rear side, device left side, or device right side at the inside of the coil portion 46 of the coil antenna 44, or part of the MR sensor 58 may protrude from the coil portion 46. Namely, it is sufficient that at least a portion of the MR sensor 58 be inside the coil portion 46.

Moreover, in the first exemplary embodiment, the coil portion 46 of the coil antenna 44 is wound around the coil placement portion 48 of the cover 14 (upper cover 14A). However, for example, the coil portion 46 of the coil antenna 44 may be embedded within the protector 52, with the protector 52 being mounted to the cover 14. Moreover, in each of the exemplary embodiments described above, the MR sensor 58 is applied as the magnetic sensor. However, the magnetic sensor may, for example, be a Hall effect sensor. The specific configuration of the magnetic sensor is not limited so long as changes in magnetism or the like can be detected.

Moreover, in each of the exemplary embodiments described above, the coil portion 46 of the coil antenna 44 suppresses both magnetism and electromagnetic waves from the outside of the coil portion 46 from influencing the MR sensor 58 inside the coil portion 46. However, it is sufficient that the coil portion 46 suppress at least one out of magnetism or electromagnetic waves from the outside of the coil portion 46 from influencing the MR sensor 58 inside the coil portion 46.

Moreover, in each of the exemplary embodiments described above, the antenna is configured by the coil antenna 44 that includes the coil portion 46. However, the antenna may, for example, be rod-shaped. Namely, the specific configuration of the antenna is not limited so long as the antenna is capable of at least one out transmission or reception of electrical signals, and is also capable of suppressing at least one out of electromagnetic waves or magnetism from influencing the magnetic sensor.

What is claimed is:

1. A buckle device comprising:
a buckle into which a tongue of a seatbelt device is inserted and that engages with the tongue;
a magnetic sensor that is provided at the buckle and that detects surrounding changes in magnetism; and
an antenna that is provided at the buckle, that is configured to at least transmit an electrical signal to outside of the buckle or receive an electrical signal from outside of the buckle, that is disposed overlapping at least a portion of the magnetic sensor, and that is configured to suppress electromagnetic waves or magnetism from outside of the buckle from influencing the magnetic sensor.

2. The buckle device of claim 1, wherein the antenna includes a coil portion formed in a coil shape, and at least a portion of the magnetic sensor is disposed inside the coil portion.

3. The buckle device of claim 2, wherein the coil portion of the antenna is wound around a portion of the buckle at a side through which the tongue is inserted.

4. The buckle device of either claim 2 or claim 3, wherein the buckle includes:
a buckle body including an engagement member that engages with the tongue; and
a cover, the buckle body being provided inside the cover, and the coil portion of the antenna being wound around the cover.

5. The buckle device of either claim 1 or claim 2, wherein:
the buckle includes:
a buckle body including an engagement member that engages with the tongue, and
a cover, the buckle body being provided inside the cover; and
the antenna is provided at a side of the buckle body inside the cover.

6. The buckle device of claim 2, wherein:
the buckle includes:
a buckle body including an engagement member that engages with the tongue, and
a cover, the buckle body being provided inside the cover; and
the coil portion is provided at least at a side of the buckle body inside the cover.

7. The buckle device of claim 2, wherein at least the coil portion of the antenna is covered by an insulating covering material, and a surface of the covering material is configured including a magnetic material having a relative permeability greater than 1.
